(19) United States
(12) Patent Application Publication
(10) Pub. No.: US 2004/0120542 A1
(43) Pub. Date: Jun. 24, 2004

(54) Loudspeaker with a bellow-shaped surround

(76) Inventor: Richard L. Morris III, Wrightstown, NJ (US)

Correspondence Address: Richard L. Morris III, P.O. Box 817, Wrightstown, NJ, 08562, US

(21) Appl. No.: 10/697,327

(22) Filed: Oct. 31, 2003

Related U.S. Application Data
(60) Provisional application No. 60/422,608, filed on Nov. 1, 2002.

(51) Int. Cl. H04R 1/00; H04R 9/06; H04R 11/02

(52) U.S. Cl. 381/396; 381/433

(57) ABSTRACT

An improved loudspeaker having a dust cap (20), a cone (22) bellow-shaped surround (24), a basket (26), a magnet (28), a voice coil (30), and a spider (32), which can achieve longer excursions. The bellow-shaped surround is perpendicular to the cone (22) and the top of the basket (26). The shape and position of the surround allows the loudspeaker to achieve high sound pressure levels and reproduce precise sound.

### BACKGROUND OF INVENTION

The invention relates to loudspeakers, specifically to such loudspeakers, which high sound pressure levels (SPLs) are needed.

1. Background Discussion of Prior Arts

In my patent research, I noticed that there are different types of loudspeakers. However, There is no loudspeaker in which the surround is bellow-shaped and is perpendicular to the cone.

2. Disadvantages of Prior Arts and Advantages of Invention

Loudspeakers of today are a lot more advanced than the loudspeakers of the past. The materials and designs that are used now, allow loudspeakers to reproduce more precise sound quality. Also, because of oversized magnets and heavy-duty voice coils, loudspeakers have longer excursions and they can achieve higher sound pressure levels (SPL). However, because of the longer excursion the loudspeaker's cone needs the ability to move farther. To compensate for the longer excursion, loudspeaker manufacturers make the cones smaller and the surround larger. This creates a problem, because the cone's surface area is smaller so the cone is moving less air.

For example, a 12-inch loudspeaker (30 cm) could have a cone of an 8-inch loudspeaker (20 cm). Because of that, the 12-inch loudspeaker (30) is only little better than an 8-inch (20 cm) or 10-inch (25 cm) loudspeaker. The loudspeaker's surround's excursions also reproduce sound. However, the surround is no as rigid as a cone so it cannot reproduce sounds as well a cone.

The invention remedies this problem. The invention's surround allows for long excursions, but it does not compensate cone surface area.

### SUMMARY

In accordance with the present invention a loudspeaker comprises a dust cap, a cone, a basket, a bellow-shaped surround, and a spider.

### DESCRIPTION OF DRAWINGS

FIG. 1 is an isometric view of the loudspeaker with a bellow-shaped surround.

FIG. 2 is a sectional view of the loudspeaker with a bellow-shaped surround.

FIG. 3 is a sectional view of a conventional loudspeaker.

### DESCRIPTION OF INVENTION

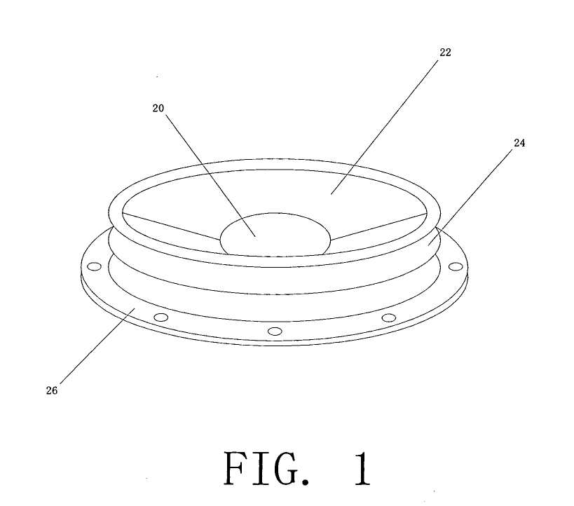

FIG. 1 is an isometric view of the loudspeaker with a bellow-shaped surround. In this view, the dust cap (20), the cone (22), the bellow-shaped surround (24), and the top of the basket (26) can be seen. The bellow-shaped surround (24) is perpendicular to the cone (22). The dust cap (20) is connected to the cone (22). The surround (24) is connected to the cone's outer edge. The basket (26) is connected to the surround (24).

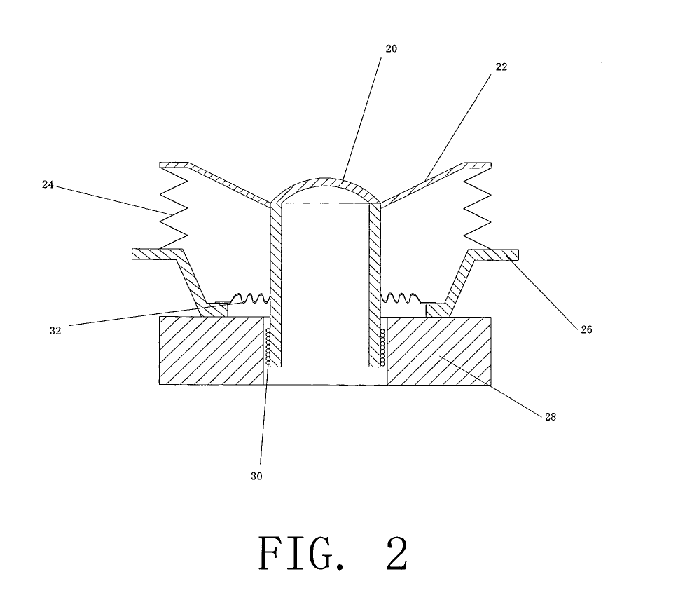

FIG. 2 is a sectional view of the loudspeaker with a bellow-shaped surround. In this view, the dust cap (20), the cone (22), the bellow-shaped surround (24), the basket (26), the magnet (28), the voice coil (30), and spider (32) can be seen. How the bellow-shaped surround is connected to the basket and the cone can be seen. The bellow-shaped surround (24) is perpendicular to the cone (22). The dust cap (20) is connected to the cone (22). The surround (24) is connected to the cone's outer edge. The basket (26) is connected to the surround (24). The voice coil (30) is connected to the bottom of the cone and to the positive and negative terminals (not shown). The basket (26) is connected to the outer edge of the spider (32). The voice coil (30) is connected to the inner edge of the spider (32). The magnet (28) is connected to the bottom of the basket (26).

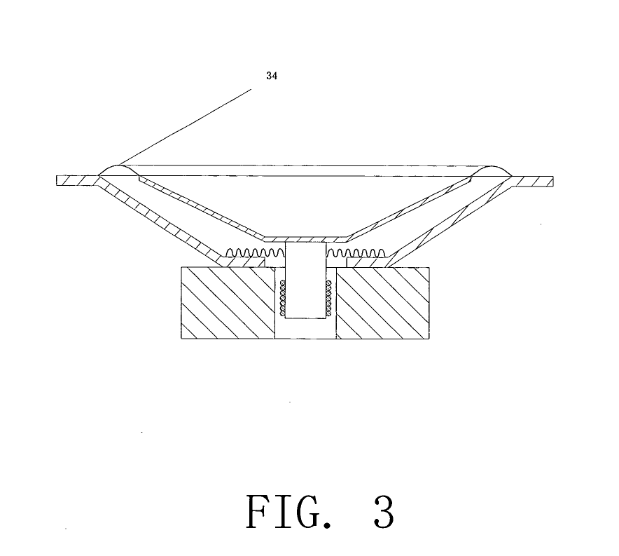

FIG. 3 is a sectional view of a conventional speaker. The conventional surround (34) can be seen.

### REFERENCE NUMBERS

20 Dust cap 28 Magnet

22 Cone 30 Voice Coil

24 Bellow-shaped surround 32 Spider

26 Basket 34 Conventional surround

Operation

The loudspeaker with a bellow-shaped surround operates similar to a conventional loudspeaker. However, because of the position and the shape of the surround, the loudspeaker has a very long excursion and the ability to reproduce precise sound. The long excursion would allow the loudspeaker to produce very high sound pressure levels (SPLs). The shape of the surround allows it to retract and extend like an accordion.

### CONCLUSION, RAMIFICATIONS, AND SCOPE

Accordingly, the reader will see that the surround of the loudspeaker is positioned in a way that optimizes the loudspeaker's cone's excursion length and will reduce the stress on the loudspeaker's surround, which will reduce the chance of ripping the surround. In addition, the surround allows the use larger and more powerful motor structures. Furthermore, the loudspeaker with a bellow-shaped surround has the additional advantages in that

it permits the use of bigger cones than other loudspeakers of the same size and power;

it allows the user to use a lower number of loudspeakers, because it can move more air than loudspeakers of the same size and power;

it saves the user money, because there is less chance of needed repair or replacement.

it provides a cooler environment for the motor structure, because the longer excursions are able to vent more air through the motor structure;

it provides more options for the user in loudspeaker cabinet design, shape, and size.

Although the description above contains many specificities, these should not be construed as limiting the scope of the invention, but as merely providing illustrations of some of the presently preferred embodiments of this invention. For example, in both figures the bellow-shaped surround has an accordion shape. However, the loudspeaker' surround does not have to have an accordion shape, because not all bellows have an accordion shape design.

Thus the scope of the invention should be determined by the appended claims and their legal equivalents, rather than by the examples given.

1) A device having a cone, a surround, a basket, a spider, a voice coil, and a magnet.
(a) Said surround from claim 1 is perpendicular to the basket and the cone's outer edge.
(b) Said surround from claim 1 is bellow-shaped.
